(19) United States
(12) Patent Application Publication
(10) Pub. No.: US 2011/0139872 A1
(43) Pub. Date: Jun. 16, 2011

(54) System and Method for Capturing Write-In Selections on a Paper Ballot

(75) Inventor: McDermot Shafer Coutts, San Diego, CA (US)

(73) Assignee: International Lottery and Totalizator Systems, Inc, Vista, CA (US)

(21) Appl. No.: 12/965,539

(22) Filed: Dec. 10, 2010

Related U.S. Application Data
(60) Provisional application No. 61/285,621, filed on Dec. 11, 2009.

(51) Int. Cl. G07C 13/00

(52) U.S. Cl. 235/386

(57) ABSTRACT

A system for separating write-in entries from the paper ballots electronically without resorting to manual or mechanical separation is configured to detect when a write-in selection is made in a designated write-in area of a paper ballot as a paper ballot is read through a digital scanner or other imaging device. An image of the write-in entry area (a sub-image of the total ballot) is then extracted and stored with appropriate data keys on a storage medium for later retrieval and processing by qualified personnel.

### RELATED APPLICATION

The present application claims priority to U.S. provisional patent application Ser. No. 61/285,621 filed 11 Dec. 2010, which is incorporated herein by reference in its entirety.

### BACKGROUND

1. Field of the Invention

The present invention is generally related to conducting elections and more specifically related to processing paper ballots that include a write-in selection.

2. Related Art

Write-In candidates are candidates that are not officially printed or displayed as part of the official ballot. The voter is given the option to write the name of their desired candidate instead of selecting one of the registered candidates. The onus then falls upon a voting jurisdiction to separate, read and aggregate these write in values and integrate the votes into the election totals. When using paper ballots, the write in capture process has always been manual. There has been some augmentation of the process through the use of mechanical diverters that will physically separate paper ballots that have write in entries into a discreet location from those without so that they can be more easily processed. However, this still requires a lengthy and expensive manual process that is prone to error.

Therefore, what is needed is a system and method that overcomes these significant problems found in the conventional systems as described above.

### SUMMARY

The system provides a method for separating write in entries from the paper ballots electronically without resorting to manual or mechanical separation. From the election definition, the system detects when a write-in selection is made as a paper ballot is read through a digital scanner or other imaging device. This system then extracts an image of the write-in entry area (a sub-image of the total ballot image) and stores it with appropriate data keys on a storage medium for later retrieval and processing by qualified personnel. Alternatively or in addition to storing the sub-image, the system may record the coordinates of the sub-image along with an identification of the corresponding total ballot image to allow for later processing of the sub-image portion that contains the write-in selection.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram illustrating one embodiment of a system for handling write-in selections on a paper ballet;

FIG. 2 is a flow diagram illustrating a process for handling write-in selections on a paper ballot according to an embodiment of the invention, using the system of FIG. 1; and

FIG. 3 is a block diagram illustrating an example computer system that may be used in connection with various embodiments described herein.

### DETAILED DESCRIPTION

Certain embodiments as disclosed herein provide for a system and method for capturing write-in selections on a paper ballot. For example, one method as disclosed herein allows for capturing and extracting an image of a write-in selection on a paper ballet, and storing the captured image for later retrieval and processing.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

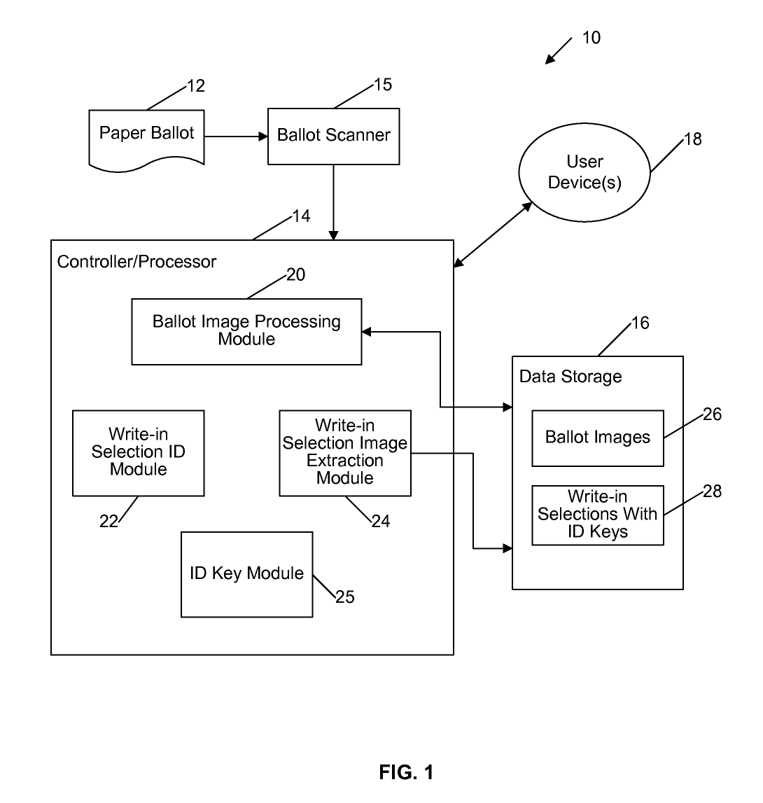

FIG. 1 illustrates one embodiment of a system 10 for capturing and saving write-in selections from a paper ballot 12. In the illustrated embodiment, the system 10 comprises one or more processors or controllers, such as a controller or processor 14, and associated devices comprising a digital scanner or other imaging device 15 and a data storage device 16 which may comprise some or all of the following, as described in more detail below in connection with FIG. 4: a hard disk drive, removable storage drive, main memory, removable storage medium, and the like. User devices 18 such as laptops, personal computers, and the like may also be communicatively coupled with the controller or processor 14 to allow election personnel to retrieve and view scanned ballots and extracted write-in selections from ballots for tabulation purposes.

The scanner or other imaging device and any user devices may be communicatively coupled with the processor 14 in any suitable manner, including local or remote connections via one or more wired or wireless networks, such as mobile or telephone networks, public or private computer networks, or the Internet, with appropriate security systems for privacy purposes. Alternatively, processor 14 may be integrated with scanner 15 to capture write-in selections as the image is scanned.

The controller or processor 14 comprises a ballot image processing module 20, including a write-in selection identification module 22 which identifies entry of any information in any pre-designated write-in entry area of a scanned ballot, and a write-in selection image extraction module 24 which isolates and extracts sub-images of the write-in selections only from a paper ballot, using the election definition which defines which regions of a paper ballot are intended for users to write in the name of their desired candidate instead of selecting one of the registered candidates. An identification (ID) or data key generating module 25 associates appropriate unique data keys for storing with each extracted write-in selection sub-image, for later retrieval and processing by qualified election personnel. Complete ballot images 26 and extracted sub-images 28 of the extracted write-in areas of the scanned ballots along with the associated ID/data keys are stored in data storage module 16, along with other data such as stored program instructions, election definitions, and the like.

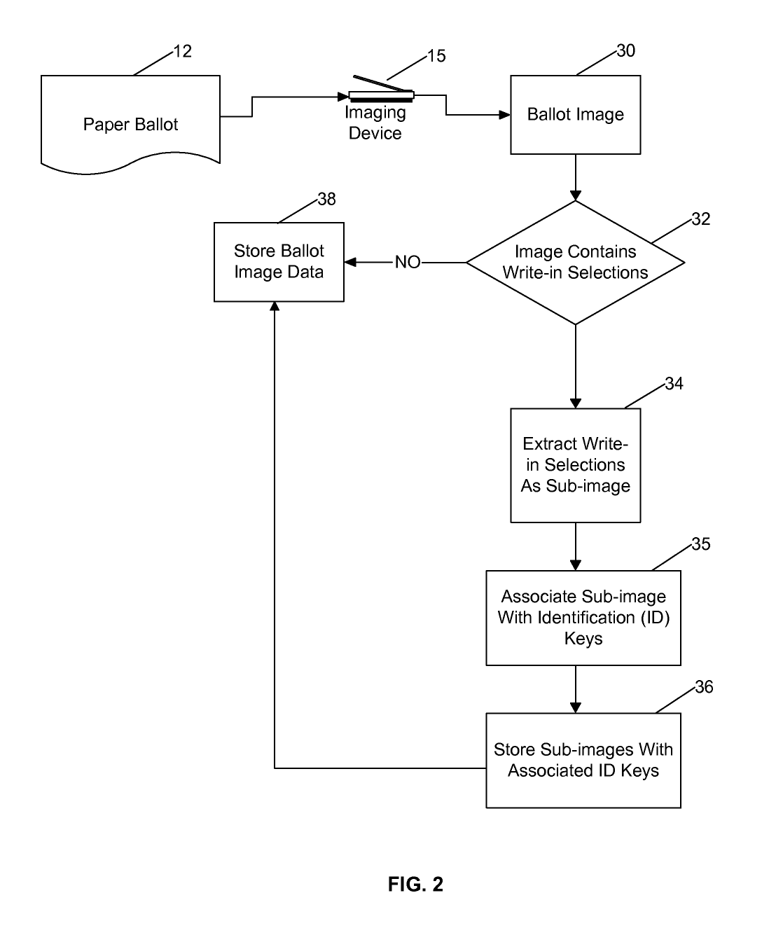

FIG. 2 illustrates one embodiment of a method of capturing write-in selections on a paper ballot using the system of FIG. 1. As illustrated in FIG. 2, the paper ballot 12 is scanned by imaging device 15 to produce a scanned ballot image 30. The processor is configured to determine whether a write-in selection has been made in any predefined write-in region or designated write-in area of the ballot, using the stored ballot definition to identify the designated write-in region (32). This may be done as the ballot is scanned, using optical character recognition (OCR) or other tools to detect indicia in the write-in region. Alternatively, the scanned image may be further analyzed after scanning to identify write-in indicia. If indicia are detected in the write-in region of any ballot, an image of the write-in selection is extracted as a sub-image (34) and associated with unique identification (ID) or data keys (35). The extracted sub-images from any scanned paper ballots are stored along with the respective ID keys (36). Alternatively or in addition to storing the sub-image, the system may record the coordinates of the sub-image along with an identification of the corresponding total ballot image to allow for later processing of the sub-image portion that contains the write-in selection. The complete ballot image data may also be stored (38), regardless of whether write-in selections are present. Alternatively, if there is no selection on the ballot other than a candidate for which a write-in may be entered, the ballot image data indicating the selected official data is stored, while the extracted write-in selection sub-image only is stored if present. An additional method of storing the write-in selections is as a set of coordinates (x, y, height, width), referencing a location on the original image, as well as extracting the image from the ballot.

Instead of simply allowing retrieval of a paper ballot for manual processing, this system and method allows for the easy extraction, storage and retrieval of the pertinent areas of a paper ballot for assessment. The individual sub-images of the write-in portions of ballots containing voters' write-in selections can be aggregated, sorted and processed with minimum time using a variety of tools, including but not limited to, Optical Character Recognition (OCR) and manual interpretation. Resulting interpretations could be automatically included in election results with minimum time lag. Accordingly, once the sub-images have been stored (regardless of whether the total ballot image is also stored) or once the sub-image coordinates have been stored and the corresponding total ballot image has also been stored, the write-in selection can be evaluated manually (by visual inspection) or by software utility and associated with a valid candidate or rejected. Advantageously, the system and method provides a complete record and audit trail of all accepted and rejected write-in entries and associated reasons for rejection and other pertinent information can also be stored and thereby preserved for comprehensive audit capabilities of the write-in process.

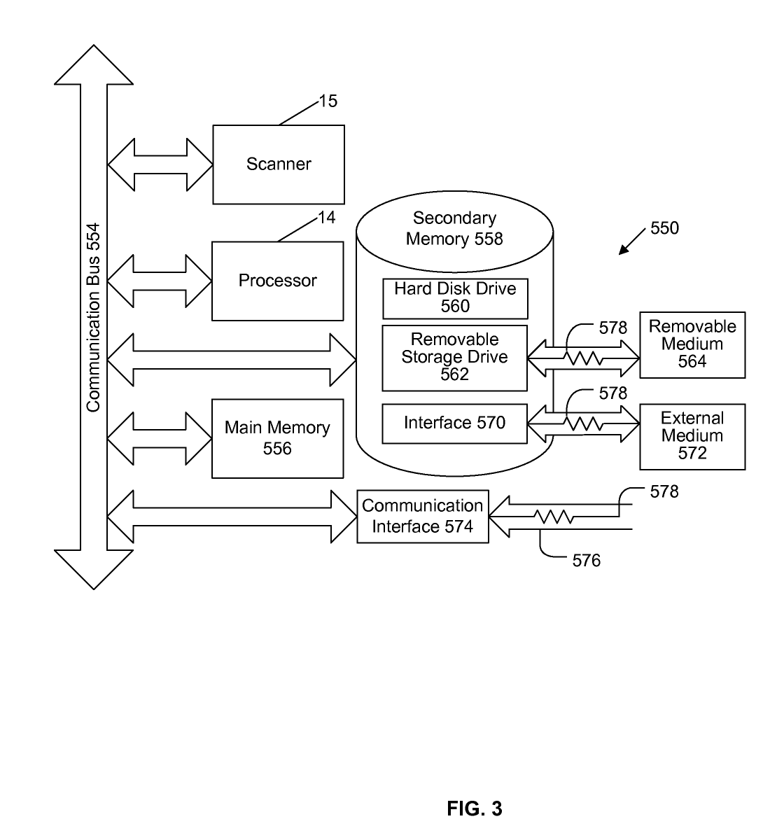

FIG. 4 is a block diagram illustrating an example computer system 550 that may be used in connection with various embodiments described herein. For example, the computer system 550 may be used in conjunction with a system for capturing write-in selections from paper ballots, as described above in connection with FIGS. 1 to 3. However, other computer systems and/or architectures may be used, as will be clear to those skilled in the art.

The computer system 550 may include one or more processors, such as processor 14. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 14.

The processor 14 is preferably connected to a communication bus 554. The communication bus 554 may include a data channel for facilitating information transfer between storage and other peripheral components of the computer system 550, including scanner or imaging device 15 as described above. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

The scanning or imaging device 15 is configured to scan or read a ballot image 30 from each paper ballot scanned, and to transfer scanned ballot images via the communication bus 554 to one or more data storage components of the system as well as the processor 14 for further processing as described above.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 may be a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, user devices 18 operated remotely by election personnel, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few. In one embodiment, the output of scanner 15 may be communicated from a remote location to the computer system via interface 574.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A system for capturing write-in selections on a paper ballot, the system comprising:
a computer readable storage device for storing computer executable programmed modules;
a processor communicatively coupled with a computer readable storage device for executing programmed modules stored therein, the modules comprising:
a write-in selection detection module which identifies any indicia in one or more pre-defined write-in regions of a paper ballot; and
an image extraction module which extracts a copy of any detected indicia from a write-in region of a scanned paper ballot and stores the extracted copy of the indicia as a sub-image in the computer readable storage device.

2. The system of claim 1, further comprising an identification key module which associates each sub-image with a respective identification (ID) key and stores each ID key along with the respective associated sub-image in the computer readable storage device.

3. A system comprising at least one processor communicatively coupled with at least one memory, wherein the processor is programmed to capture write-in selections from a paper ballot by:
analyzing at least one predefined write-in region of a paper ballot to detect any voter entered indicia in the write-in region;
extracting a sub-image of any detected indicia in the write-in region from a scanned image; and
storing the extracted write-in indicia as a sub-image in the memory.

4. The system of claim 3, wherein the processor is further programmed to associate a security identification (ID) key with the sub-image.

5. A computer implemented method for capturing write-in selections from paper ballots, where one or more processors are programmed to perform steps comprising:
analyzing at least one predefined write-in region of a paper ballot to detect any voter entered indicia in the write-in region;
extracting an image of any detected indicia in the write-in region from the ballot; and
storing the extracted write-in indicia as a sub-image in the memory.

6. The method of claim 5, wherein the step of analyzing at least one predefined write-in region comprises detecting indicia in the write-in region as the paper ballot is read through a scanning device.

7. The method of claim 5, wherein the step of analyzing at least one predefined write-in region comprises detecting indicia in the write-in region of a scanned image of the paper ballot.

8. The method of claim 7, further comprising storing a scanned image of the paper ballot in addition to any extracted sub-image.

9. A non-transitory computer readable medium having stored thereon one or more sequences of instructions for causing one or more processors to perform the steps for capturing write-in selections from paper ballots, the steps comprising:
analyzing at least one predefined write-in region of a paper ballot to detect any voter entered indicia in the write-in region;
extracting a copy of any detected indicia from the write-in region; and
storing the extracted write-in indicia as a sub-image in the memory.
